(19) United States
(12) Patent Application Publication
(10) Pub. No.: US 2026/0009373 A1
(43) Pub. Date: Jan. 8, 2026

(54) DAMPING ARRANGEMENT FOR A WIND TURBINE

(71) Applicant: Vestas Wind Systems A/S, Aarhus N (DK)

(72) Inventors: Mranal Gupta, Lystrup (DK); Antonio Patricio Pinto Couto Vieira, Penafiel (PT); Victor Tienda Miguel, Aarhus C (DK); Kristian Kiib, Skodstrup (DK)

(73) Assignee: Vestas Wind Systems A/S, Aarhus N (DK)

(21) Appl. No.: 18/881,968

(22) PCT Filed: Jun. 21, 2023
(86) PCT No.: PCT/DK2023/050159

§ 371 Date: Jan. 7, 2025

(30) Foreign Application Priority Data
Jul. 8, 2022 (DK) PA202270369

(51) Int. Cl. F03D 7/02; F16F 7/10; F16F 7/104

(52) U.S. Cl. CPC F03D 7/0298; F16F 7/1011; F16F 7/104; F05B 2260/964; F16F 2222/08; F16F 2228/066; F16F 2230/0047; F16F 2230/18

(57) ABSTRACT

A damping arrangement for a wind turbine is provided. The damping arrangement (20) comprises a base (24) affixable to a surface (40) of the wind turbine (2); and a magnet 5 arrangement. The magnet arrangement comprises a first magnet (38) and a second magnet (54). The first magnet (38) is fixed relative to the base (24) and is arranged to generate a first magnetic field. The second magnet (54) is supported by the base (24) to be spaced from the first magnet (38) when the base (24) is fixed to the surface (40), and is arranged to generate a second magnetic field that interacts with the first magnetic field 10 to generate a magnetic force that acts between the first and second magnets (28, 54). At least one of the first and second magnetic fields is variable.

### TECHNICAL FIELD

The present disclosure generally relates to an arrangement and corresponding method for damping vibration in a wind turbine.

### BACKGROUND

Typical wind turbine generator (WTG) components vibrate in operation, the magnitude and frequency of the vibration being dependent on wind loading, the rotational speed of the rotor and other operating factors. This vibration contributes to fatigue stress in the components of the WTG and so can shorten component lifespan. Also, vibration generated in rotating components of a WTG, such as a gearbox or other parts of a drivetrain for example, can be transferred through the structure of the WTG and emitted as noise from the tower, nacelle or the blades, therefore contributing to tonal noise, or tonality. It is desirable to limit the level of tonal noise produced by a WTG, for example to comply with operating regulations.

It is known to install vibration damping arrangements on and/or in WTGs, for example within the nacelle, to counteract oscillations and to prevent resonance from developing. However, these arrangements typically rely on mechanical or fluid devices for absorbing energy from the resonant system. Such devices are generally large and heavy, meaning that the damping arrangement can be difficult and costly to install and maintain within the limited space available in the nacelle.

In addition, WTG resonances may be excited at multiple different frequencies depending on operating conditions, for example the rotational speed, and so damping arrangements that are tuned to mitigate resonance at a particular frequency will fail to damp other resonances. In the worst case, tuned damping arrangements may exacerbate resonance at frequencies other than that for which they are tuned.

It is against this background that the invention has been devised.

### SUMMARY OF THE INVENTION

According to one aspect of the invention, a damping arrangement for a wind turbine is provided. The damping arrangement comprises a base affixable to a surface of a wind turbine, and a magnet arrangement. The magnet arrangement comprises a first magnet and a second magnet. The first magnet is fixed relative to the base and is arranged to generate a first magnetic field. The second magnet is supported by the base to be spaced from the first magnet when the base is fixed to the surface. The second magnet is arranged to generate a second magnetic field that interacts with the first magnetic field to generate a magnetic force that acts between the first and second magnets. In this way, the magnetic force acts to damp or cancel out vibration in the surface. At least one of the first and second magnetic fields is variable so that vibrations of varying frequencies can be addressed.

Such an arrangement for generating a magnetic force which acts to damp or cancel out vibration in the surface provides a lightweight and space saving solution for reducing or preventing tonal noise in a wind turbine. As the first magnetic field and/or the second magnetic field is variable, the magnitude of the magnetic force for a given spacing between the first and second magnets can be varied and controlled. This, in turn, allows the magnetic force to be manipulated to act as a damping force that can target vibrations at a range of different frequencies.

The base may comprise the first magnet, which may be a permanent magnet. Alternatively, the first magnet may comprise a solenoid and/or an electromagnet. By integrating the first magnet with the base, the damping arrangement may be magnetically coupled to the surface of the wind turbine, thus advantageously mitigating the need for additional connecting means which may add weight and bulk to the arrangement and which may result in stress concentrations in the surface.

The second magnet may also comprise a solenoid and/or an electromagnet. In embodiments wherein the first magnet is a solenoid and/or an electromagnet, the second magnet may be a permanent magnet. The damping arrangement may comprise a substantially rigid coupling that couples the second magnet to the base. A rigid coupling is particularly advantageous in embodiments which cancel out surface vibration actively, since a rigid coupling transfers the force driving anti-phase vibrations to the surface efficiently.

As an alternative to a rigid coupling, the damping arrangement may further comprise a damping mass and a spring arrangement. In such embodiments, the damping mass is supported by the base for movement relative to the base while being fixed relative to the second magnet. Correspondingly, the spring arrangement is configured to act between the base and the damping mass to bias the damping mass relative to the base. For example, the spring arrangement may be configured to bias the damping mass away from the base, or towards the base. Together, the damping mass and the spring arrangement act as a tuned mass damper, otherwise known as a harmonic absorber or dynamic absorber. In some embodiments, the second magnet may comprise the damping mass. In such embodiments, the second magnet may comprise a solenoid arranged around the damping mass. The solenoid may be fixed relative to the damping mass to form an electromagnet.

The spring arrangement may comprise one or more resilient members, such as a spring including coil springs or leaf springs, or an element of resilient material. The spring arrangement may be made from rubber, coiled metal, or any other suitable material.

The damping arrangement may further comprise a sensor, such as a displacement sensor, configured to generate a signal indicative of a spacing between the base and the damping mass, which sensor may be mounted on the base or on the surface beside the base, for example. The damping arrangement may additionally or alternatively comprise a sensor configured to generate a signal indicative of vibration on the surface, such as an accelerometer optionally mounted on the base or on the surface beside the base, for example.

The damping arrangement may further comprise a controller configured to control the magnet arrangement to vary the magnetic force. In embodiments comprising the sensor configured to generate a signal indicative of vibration on the surface, the controller may be configured to control the magnet arrangement in accordance with the signal. More preferably, the controller may be configured to control the magnet arrangement to vary the magnetic force in anti-phase to the indicated vibration. In embodiments comprising the damping mass and the spring arrangement, the controller may be configured to control the magnet arrangement to vary the magnetic force to emulate an altered spring stiffness for the spring arrangement. In such embodiments further comprising the sensor configured to generate a signal indicative of a spacing between the base and the damping mass, the controller may be configured to control the magnet arrangement in accordance with the signal. In each case, the controller may be configured to control the magnet arrangement in accordance with a signal indicative of an operational parameter of the wind turbine including any one or more of: a generator speed or a derivative thereof; a rotor speed or a derivative thereof; a blade pitch; or a power output.

According to another aspect of the invention, a damping system for a wind turbine is provided. The damping system comprises a base, a damping mass, a spring arrangement, a magnet arrangement, and a controller. Similar to embodiments described above, the base is affixable to a surface of the wind turbine and supports the damping mass for movement relative to the base, when the base is fixed to the surface. The spring arrangement is configured to act between the base and the damping mass to bias the damping mass relative to the base, for example away from the base or towards the base. The magnet arrangement is configured to generate a variable magnetic force that acts on the damping mass, and the controller is configured to control the magnet arrangement to generate the variable magnetic force.

The magnet arrangement may comprise a magnet that is fixed relative to the damping mass.

The damping system may comprise the damping arrangement of the above aspect such that the base, damping mass, spring arrangement, and magnet arrangement of the damping system are defined by the corresponding features of the damping arrangement.

The invention further extends to a wind turbine comprising the damping system or the damping arrangement of the above aspects.

According to a third aspect of the invention, a method of damping vibration in a wind turbine is provided. The method first comprises fixing a first magnet to a surface of the wind turbine, the first magnetic being arranged to generate a first magnetic field. The method further comprises supporting a second magnet in a position spaced from the first magnet so that the second magnet is arranged to generate a second magnetic field that interacts with the first magnetic field to generate a magnetic force that acts between the first and second magnets to damp vibration in the surface. The method further comprises varying at least one of the first and second magnetic fields to vary the magnetic force.

### BRIEF DESCRIPTION OF THE DRAWINGS

So that it may be more fully understood, the invention will now be described, by way of example only, with reference to the following drawings, in which like features are assigned like reference numerals, and in which:

FIG. 1 is a front view of a wind turbine comprising a damping arrangement according to an embodiment of the invention;

FIG. 2 is a transverse cross-sectional view of the wind turbine of FIG. 1, showing a damping arrangement; and

FIG. 3 is a schematic representation of a damping arrangement according to an embodiment of the invention.

### DETAILED DESCRIPTION

In general terms, embodiments of the invention provide damping arrangements which use magnetic interactions to remove energy from an oscillating system. The described embodiments are particularly suitable for installation or retrofitting in a wind turbine to damp vibration generated by rotating components and thereby mitigate tonal noise, although in principle embodiments of the invention could be used to dampen vibrations in various structures.

In embodiments to be described, the damping arrangements include magnet arrangements that are configured to generate a variable magnetic force that acts on components of the damping arrangement to damp vibration in a surface on which the arrangement is mounted, which magnetic force therefore defines a damping force.

The magnet arrangement may be used in combination with a tuned mass damper, for example, in which case the damping force may act on a damping mass of the tuned mass damper. For example, the damping force may be controlled to create variable resistance to movement of the damping mass, therefore augmenting a biasing force provided by a spring arrangement supporting the damping mass and so emulating the effect of altering the stiffness of the spring arrangement. Altering this stiffness, in turn, changes the frequency for which the mass damper is effectively tuned and therefore enables various resonant frequencies to be targeted.

Alternatively, the damping force may be controlled in accordance with measurements of vibration in the mounting surface, for example to vary the damping force in anti-phase to the measured vibration and therefore provide active damping that actively cancels vibrations in the wind turbine surface. The damping force may oscillate to act in opposing directions, for example, or may act in one direction only but with varying magnitude.

The arrangements may comprise a base for attaching the arrangement to the wind turbine, and a magnet arrangement that is at least partially supported by the base. The magnet arrangement may include first and second magnets, where the first magnet is fixed relative to the base and the second magnet is supported by the base, for example through a support structure connected to the base, so that the first and second magnets are mutually spaced. In some embodiments, the first magnet defines the base. The first and second magnets are configured to produce respective magnetic fields that interact to produce the damping force, which therefore acts between the magnets in this case, for example as a repulsive force that acts to push the magnets apart. At least one of the magnetic fields is variable so that the damping force is correspondingly variable. For example, one or both of the magnets may comprise a solenoid or an electromagnet. Either of the first and second magnets may comprise a permanent magnet.

It is also possible for the magnet arrangement to comprise a single variable magnet that generates the damping force, however.

By making use of magnetic interactions to either modify the damping properties of the arrangement or to drive an antiphase damping oscillation, embodiments of the invention provide for variable damping that can target resonances at multiple distinct frequencies, and therefore account for changing operating conditions in a WTG. The described arrangements may also remove the need for otherwise large and heavy mechanical or fluid damping devices. Accordingly, the described arrangements provide a lighter, more compact damping solution which may be more easily installed within the limited space available in a wind turbine.

If the base comprises a magnet of the magnet arrangement, advantageously the magnetism of the base allows for the damping arrangement to be magnetically coupled to a ferromagnetic surface of the wind turbine, particularly if the magnet is a permanent magnet. This avoids the need for mechanical fasteners which require holes to be drilled in the surface of the wind turbine and the base. In turn, stress concentrations and fatigue issues that can arise around holes and mechanical fasteners are removed. Further, vibrations between the surface of the wind turbine and the damping arrangement are reduced, meaning that the effectiveness of the damping arrangement is improved. By removing the need for mechanical fasteners, installation and placement of the damping arrangement is simplified, meaning that the arrangement is also suitable for retrofitting in an existing wind turbine.

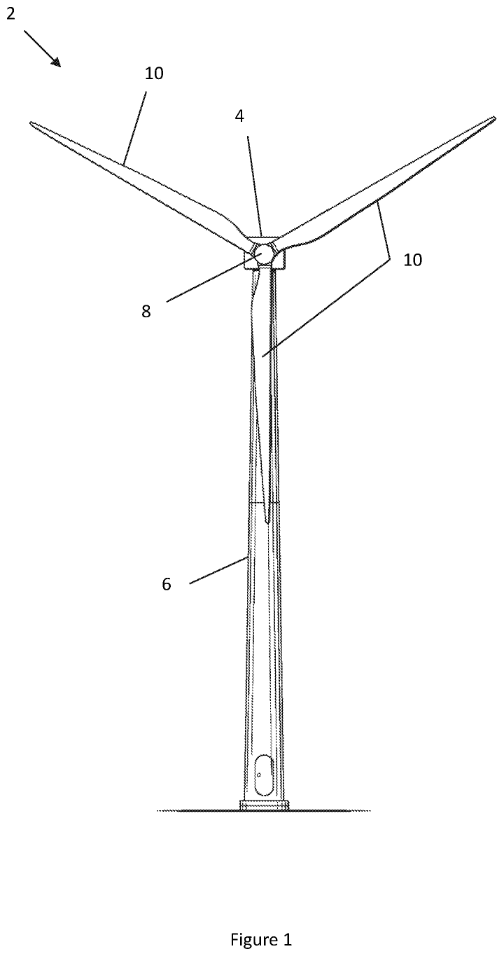

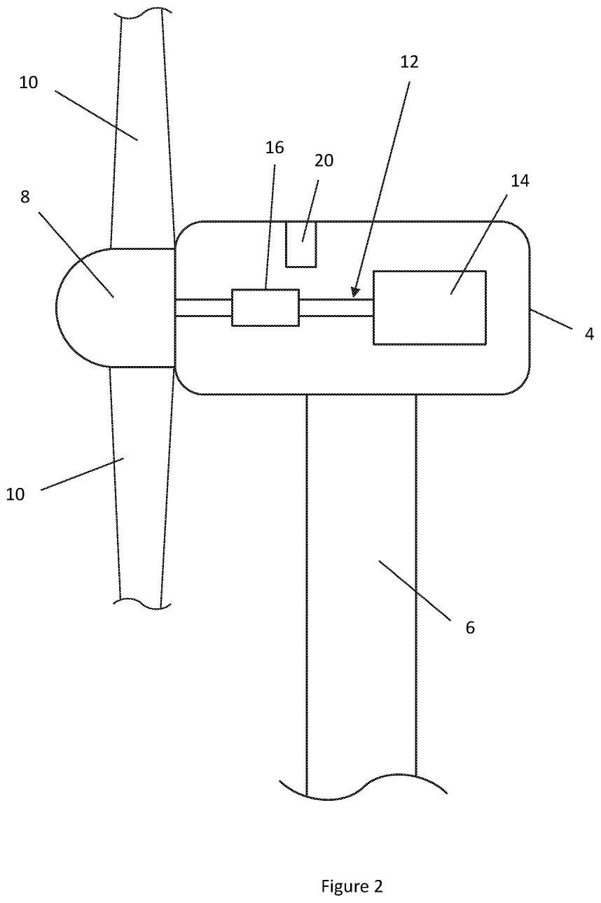

To provide context for the invention, FIG. 1 shows a typical horizontal axis WTG, also referred to below as a wind turbine 2, that includes a nacelle 4, mounted atop a tower 6, which supports a front facing rotor 8 comprising a plurality of coplanar blades 10. As shown in FIG. 2, the rotor 8 is connected to a powertrain or drivetrain 12 housed within the nacelle 4. The drivetrain 12 comprises components required to convert rotation of the rotor 8 into electricity, including a generator 14, a gear system 16 and a controller 18. When in use, unwanted vibrations generated by the rotor 8 and drivetrain components 12 are transferred to other components of the wind turbine, such as the nacelle 4 and the blades 10, leading to tonal noise.

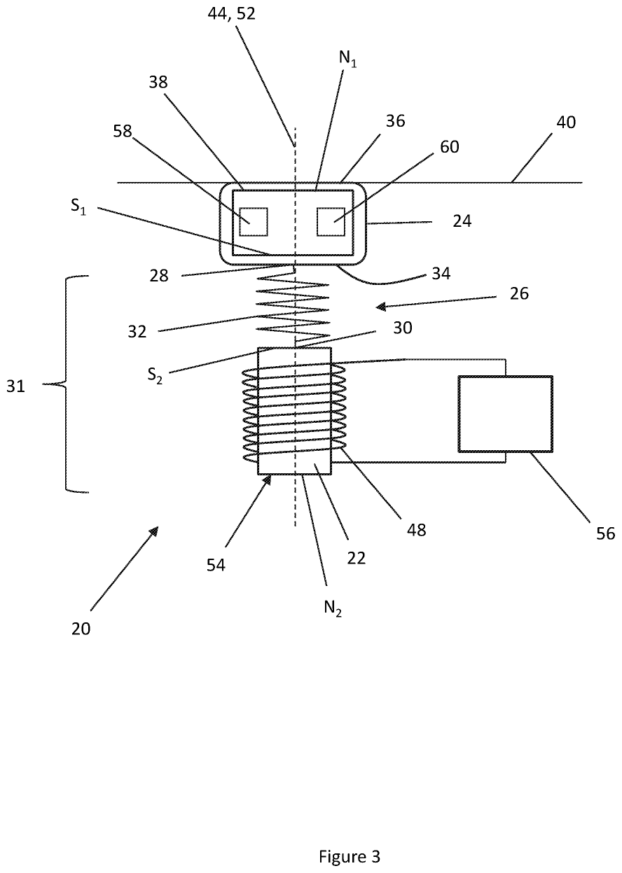

As seen in FIG. 2, a vibration damping arrangement 20 is coupled to an inside surface 22 of the nacelle 4. In this embodiment, it is contemplated that the nacelle 4 comprises an internal structural frame made from steel. As such, the damping arrangement 20 is magnetically coupled to the frame, as will be discussed further below in relation to FIG. 3. However, it will be appreciated that the placement of the damping arrangement 20 in FIG. 2 is purely illustrative, and in practice one or more damping arrangements 20 may be positioned elsewhere in the nacelle or anywhere in or on the wind turbine 2, such as on a particular drivetrain component 12, depending on where damping forces are likely to be most effective in reducing vibration.

Turning now to FIG. 3, an example of the damping arrangement 20 is shown. As seen, the damping arrangement 20 comprises a damping mass 22 coupled to a base 24 via an elastic or spring arrangement 26. In this example, the spring arrangement 26 comprises a linear spring element 32 having the general form of a coil spring, the spring element 32 having a first end 28 and an opposing second end 30. The first end 28 is coupled to the base 24 and the second end 30 is coupled to the damping mass 22. The first and second ends 28, 30 of the spring arrangement 26 may be mechanically fastened, adhered and/or integrated to or with the base 24 and the damping mass 22, respectively.

The spring arrangement and the damping mass 22 together form a damping assembly 31 defining a tuned mass damper, also referred to as a harmonic absorber or a dynamic absorber. However, unlike a conventional tuned mass damper, the effective stiffness of the damping assembly 31 is not determined only by the properties of the spring arrangement 26, but is variable. Since the frequency at which the damping assembly 31 predominantly damps vibration is related to its stiffness, the ability to vary its stiffness means that the frequency at which the damping assembly 31 damps vibration is correspondingly variable, as shall become clear from the description that follows.

The base 24 is defined by a rigid block having an upper surface 34 and a lower surface 36. The second end 30 of the spring arrangement 26 is coupled to the upper surface 34 of the base.

The base 24 comprises a permanent magnet 38 that defines a first magnet of a magnet arrangement of the damping arrangement 20. The base 24 is therefore configured to magnetically couple the damping arrangement 20 to a ferromagnetic surface 40, such as the steel frame of the nacelle 4. That is to say, the permanent magnet 38 produces a magnetic field of a size and strength suitable for inducing a sufficient attractive magnetic force between the base 24 and the surface 40 to oppose the weight of the damping arrangement 20.

More specifically, the permanent magnet 38 generates a first magnetic field and is arranged with the base 24 such that its magnetic axis (referred to as a first magnetic axis) 44 is substantially perpendicular to the surface 40. In this example, the permanent magnet 38 is oriented such that its north pole (N₁) engages the surface 40 and its south pole (S₁) faces downwardly, in the orientation shown in FIG. 3.

The damping mass 22 takes the form of a cylindrical solid mass comprising a ferromagnetic material, such as steel. The damping mass 22 is received within a coil of electrically conductive wire forming a solenoid 48, which forms part of an electric circuit. The solenoid 48 is configured to generate a second magnetic field around the damping mass 22 when electrified. Accordingly, the solenoid 48 and the damping mass 22 together form an electromagnet 54 that defines a second magnet of the magnet arrangement. The electromagnet 54 has a magnetic axis (referred to as a second magnetic axis) 52 that is aligned with a longitudinal axis of the damping mass 22. As will be understood, the characteristics of the second magnetic field may be varied by varying corresponding characteristics of the electrical current through the solenoid 48.

The damping mass 22 and the base 24 are mutually spaced and arranged relative to each other such that the first magnetic axis 44 and the second magnetic axis 52 are aligned and therefore mutually parallel. Further, the damping mass 22 is configured and oriented such that the south pole (S₂) of the electromagnet 54 is closer to the surface 40 than its north pole (N₂). In this way, the respective south poles (S₁, S₂) of the base 24 and the damping mass 22 face each other. It will be appreciated that this arrangement may be reversed so that the respective north poles (N₁, N₂) face each other instead without impacting the mode of operation described below.

The spacing of the damping mass 22 and the base 24, and the respective strengths of their magnetic fields, are such that the first and second magnetic fields overlap and interact when the electromagnet 54 is operated. Due to the relative orientations of the magnetic fields, the base 24 and the damping mass 22 are configured to magnetically repel each other when the electromagnet 54 is operated. In other words, when the electromagnet 54 is activated, a repulsive magnetic force is generated between the base 24 and the damping mass 22, the magnitude of the magnetic force being variable in dependence on the current applied to the solenoid 48.

The magnitude of the magnetic force is also dependent on the relative positions of the first and second magnetic fields and so varies as the damping mass 22 moves. In general, the magnetic force increases as the damping mass 22 moves towards the base 24, if the strengths of the first and second magnetic fields are held constant.

This magnetic force supplements a biasing force or ‘spring force’ acting between the base 24 and the damping mass 22 generated by the spring element 32. In this example, the spring element 32 is configured to bias the damping mass 22 away from the base 24, and so the spring force and the magnetic force act in the same direction. The effective stiffness of the damping assembly 31 is therefore a function of the combination of the magnetic force and the spring force. As the magnetic force is variable and controllable, the effective stiffness of the damping assembly 31 is correspondingly variable and controllable. In general, increasing the magnitude of the magnetic force has the effect of increasing the overall stiffness of the damping assembly 31.

The spring force generated by the spring element 32 increases as the spring element 32 is compressed by movement of the damping mass 22, according to the stiffness of the spring element 32. In the present example, the spring element 32 is linear and hence the spring force increases linearly with compression. However, in other examples the spring element may be replaced with non-linear resilient members, such as a rubber element for example, in which case the spring force varies non-linearly as the damping mass moves 22.

The magnetic force defined by magnetic repulsion between the first and second magnets also increases generally linearly as the magnets move together, which in the present example complements the profile of the spring force. In other examples in which resilient members are used that produce a non-linear spring force, this can be accounted for by monitoring the movement of the damping mass 22 and controlling the magnetic force accordingly. This may entail varying the magnetic force in a corresponding manner to the spring force as the damping mass 22 moves, to match the non-linear profile of the spring force, or varying the magnetic force to compensate for the non-linearity of the spring force so that the overall stiffness of the damping arrangement is linear. In this way, the magnet arrangement can be operated to emulate an increase in the stiffness of the spring element 32.

In turn, an effectively stiffer damping assembly 31 absorbs resonance at a higher frequency when the base 24 is excited. Accordingly, the magnet arrangement can be operated to increase the effective stiffness of the damping assembly 31 to target resonances at higher frequencies, and correspondingly the effective stiffness of the damping assembly 31 may be decreased to target resonances at lower frequencies.

The damping arrangement 20 further comprises a controller 56 configured to operate in a dynamic mode. According to the dynamic mode, the controller is configured to receive signals indicative of rotor and/or generator speed and determine, based on these signals, the vibrating frequency of the surface 40 (and by extension, the base 24). The controller is further configured to determine a target damping frequency and/or a target effective stiffness for the damping assembly 31 required to reduce the vibrating frequency, and to control the current through the solenoid 48 to achieve the target damping frequency and/or target effective stiffness. That is to say, the controller 56 is configured to dynamically adjust the strength of the second magnetic field as a way of adjusting the repulsive force between the base 24 and the damping mass 22 and, thereby, the effective stiffness of the damping assembly 31.

The controller 56 may be a dedicated controller, or it may be embodied as a control block or module within an existing controller of the wind turbine 2, such as a turbine controller.

The damping arrangement 20 further comprises a displacement sensor 58 mounted on the base 24 and communicatively coupled to the controller 56, the displacement sensor 58 being configured to generate a signal indicative of the spacing between the base 24 and the damping mass 22. Suitable sensors may include optical distance sensors, ultrasonic sensors or linear position sensors, for example. The displacement sensor 58 is configured to repeatedly measure the distance to the damping mass 22 and communicate measurement data to the controller 56. As will be understood, the measurement data over time will comprise peaks and troughs as the damping mass 22 vibrates relative to the base 24.

The controller 56 is configured to monitor the measurement data and compare the measured distance variation with an expected distance variation. Accordingly, the controller 56 is further configured to apply a corrective damping force when a lower-than-expected distance variation is measured. In this way, the displacement sensor 58 and the controller cooperate to diagnose and correct errors in the target effective stiffness.

The displacement sensor 58 also enables the movement of the damping mass 22 to be monitored, which as noted above, may be necessary if a non-linear resilient member is used to provide the spring force between the base 24 and the damping mass 22. In such cases, the controller 56 can synchronise variation of the magnetic force with the variation of the spring force, so that the magnetic force varies with a similar profile to the spring force.

Additionally, the controller 56 is configured to identify irregularities in the received distance variation data indicative of faulty operation of the damping arrangement 20 leading to impermissible tonal noise. The controller 56 may be further configured to address such faulty operation by shutting down the wind turbine 2, for example. In this way, the displacement sensor 58 and the controller 56 together act to prevent the wind turbine from operating in a condition which produces tonal noise that is incompliant with current regulations.

In this example, the controller 56 is additionally configured to operate in an active mode. For this purpose, in this example the displacement sensor 58 is accompanied by a vibration sensor 60, such as an accelerometer, that is mounted on the base 24 beside the displacement sensor 58.

The vibration sensor 60 is configured to detect vibration in the surface 40, for example the amplitude and phase of the vibration, and to communicate corresponding data to the controller 56. When in the active mode, the controller 56 is configured to control the second magnetic field so as to drive the damping mass 22 to vibrate in anti-phase with the surface 40 and thereby neutralise the surface vibrations. For example, by oscillating the current in the solenoid, the strength and/or polarity of the second magnetic field may be oscillated. In turn, the resulting oscillating magnetic force causes the damping mass to oscillate correspondingly.

When operating in the active mode, distance variation data received by the controller 56 from the displacement sensor 58 may be additionally used to inform accurate control of the anti-phase movements. Accordingly, the controller 56 may use signals received from both the displacement sensor 58 and the vibration sensor 60 simultaneously.

In other embodiments, the controller may be configured to operate in only one of the active mode and the dynamic mode, in which case only one of the vibration sensor and the displacement sensor is required.

The skilled person will appreciate that modifications may be made to the specific embodiments described above without departing from the inventive concept as defined by the claims.

For example, a damping arrangement may be configured with the spring and magnetic forces acting in different directions to the example above. The spring force could act to bias the damping mass away from the base, for example. Similarly, the first and second magnets may be oriented to produce an attractive magnetic force between them. The spring force and the magnetic force could act in opposed directions.

For damping arrangements configured to operate in the dynamic mode and including a damping assembly having a damping mass supported for movement relative to a base, in some embodiments a single magnet is used to resist or accelerate movement of the damping mass and thereby vary the effective stiffness of the arrangement. For example, a solenoid arranged around the damping mass may be configured to generate a magnetic field that acts to move the damping mass directly, for example in the manner of a solenoid actuator.

As noted above, the first and second magnets may be coupled by a rigid coupling instead of by a spring. This may be useful for damping arrangements that are configured to cancel vibration actively, as an anti-phase vibration generated in the damping arrangement may be transferred into the vibrating surface more effectively by a rigid coupling.

1. A damping arrangement for a wind turbine, the arrangement comprising:
a base affixable to a surface of the wind turbine; and
a magnet arrangement, comprising:
a first magnet that is fixed relative to the base, the first magnet being arranged to generate a first magnetic field; and
a second magnet that is supported by the base to be spaced from the first magnet when the base is fixed to the surface, the second magnet being arranged to generate a second magnetic field that interacts with the first magnetic field to generate a magnetic force that acts between the first and second magnets;
wherein at least one of the first and second magnetic fields is variable.

2. The damping arrangement of claim 1, wherein the base comprises the first magnet.

3. The damping arrangement of claim 1, wherein the first magnet comprises a permanent magnet.

4. The damping arrangement of claim 1, wherein the first magnet comprises a solenoid and/or an electromagnet.

5. The damping arrangement of claim 1, wherein the second magnet comprises a solenoid and/or an electromagnet.

6. The damping arrangement of claim 1, comprising:
a damping mass that is supported by the base for movement relative to the base, the damping mass being fixed relative to the second magnet; and
a spring arrangement acting between the base and the damping mass to bias the damping mass relative to the base.

7. The damping arrangement of claim 6, wherein the damping mass and the spring arrangement together form a tuned mass damper.

8. The damping arrangement of claim 6, wherein the spring arrangement comprises at least one resilient member.

9. The damping arrangement of claim 6, wherein the second magnet comprises the damping mass.

10. The damping arrangement of claim 9, wherein the second magnet comprises a solenoid arranged around the damping mass.

11. The damping arrangement of claim 10, wherein the solenoid is fixed relative to the damping mass.

12. The damping arrangement of claim 6, comprising a sensor configured to generate a signal indicative of a spacing between the base and the damping mass.

13. The damping arrangement of claim 1, comprising a rigid coupling that couples the second magnet to the base.

14. The damping arrangement of claim 1, comprising a sensor configured to generate a signal indicative of vibration of the surface.

15. The damping arrangement of claim 1, comprising a controller configured to control the magnet arrangement to vary the magnetic force.

16. The damping arrangement of claim 15, wherein the damping arrangement further comprises a sensor configured to generate a signal indicative of vibration of the surface, and wherein the controller is configured to control the magnet arrangement in accordance with the signal indicative of vibration of the surface.

17. The damping arrangement of claim 16, wherein the controller is configured to control the magnet arrangement to vary the magnetic force in anti-phase to the indicated vibration.

18. The damping arrangement of claim 6, wherein the damping arrangement further comprises a controller configured to control the magnet arrangement to vary the magnetic force, and wherein the controller is configured to control the magnet arrangement to vary the magnetic force to emulate an altered spring stiffness for the spring arrangement.

19. The damping arrangement of claim 18, wherein the damping arrangement further comprises a sensor configured to generate a signal indicative of a spacing between the base and the damping mass, and wherein the controller is configured to control the magnet arrangement in accordance with the signal indicative of the spacing between the base and the damping mass.

20. The damping system arrangement of claim 15, wherein the controller is configured to control the magnet arrangement in accordance with a signal indicative of any one or more of: a generator speed; a rotor speed; a blade pitch; or a power output.

21. A damping system for a wind turbine, comprising:
a base affixable to a surface of the wind turbine;
a damping mass supported by the base for movement relative to the base, when the base is fixed to the surface;
a spring arrangement acting between the base and the damping mass to bias the damping mass relative to the base;
a magnet arrangement that is configured to generate a variable magnetic force that acts on the damping mass; and
a controller configured to control the magnet arrangement to generate the variable magnetic force.

22. The damping system of claim 21, wherein the magnet arrangement comprises a magnet that is fixed relative to the damping mass.

23. The damping system of claim 21, further comprising a damping arrangement, the damping arrangement comprising:
a base affixable to a surface of the wind turbine; and
a magnet arrangement, comprising:
a first magnet that is fixed relative to the base, the first magnet being arranged to generate a first magnetic field; and
a second magnet that is supported by the base to be spaced from the first magnet when the base is fixed to the surface, the second magnet being arranged to generate a second magnetic field that interacts with the first magnetic field to generate a magnetic force that acts between the first and second magnets;
wherein at least one of the first and second magnetic fields is variable.

24. A wind turbine comprising the damping arrangement of claim 1.

25. A method of damping vibration in a wind turbine, the method comprising:
fixing a first magnet to a surface of the wind turbine, the first magnet being arranged to generate a first magnetic field;
supporting a second magnet in a position spaced from the first magnet, the second magnet being arranged to generate a second magnetic field that interacts with the first magnetic field to generate a magnetic force that acts between the first and second magnets to damp vibration in the surface; and
varying at least one of the first and second magnetic fields to vary the magnetic force.
